(19) United States
(12) Patent Application Publication
(10) Pub. No.: US 2006/0100324 A1
(43) Pub. Date: May 11, 2006

(54) Polyolefin resin composition containing diacetal

(76) Inventors: Shouichi Horie, Fukuoka (JP); Takeshi Yamanaka, Chikujo-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/534,439

(22) PCT Filed: Oct. 15, 2003
(86) PCT No.: PCT/JP03/13208

§ 371 Date: Dec. 1, 2005

(30) Foreign Application Priority Data
Nov. 15, 2002 (JP) 2002-369016

(51) Int. Cl. C08K 5/15

(52) U.S. Cl. 524/108

(57) ABSTRACT

An object of the present invention is to provide a polyolefin resin composition with excellent transparency, which is obtained by a method which is economically advantageous, and easily produces said composition, wherein said composition hardly generates white spots thought to be an insoluble part of a diacetal compound, while retaining the intact transparency imparted by the diacetal. A clarifier for polyolefin resins which comprises a combination of an acetal compound represented by the general formula (1) with a specific amount of a modifier represented by the general formula (2) or (3) is used. Thus, white spots thought to be an insoluble part of the diacetal compound can be significantly diminished.

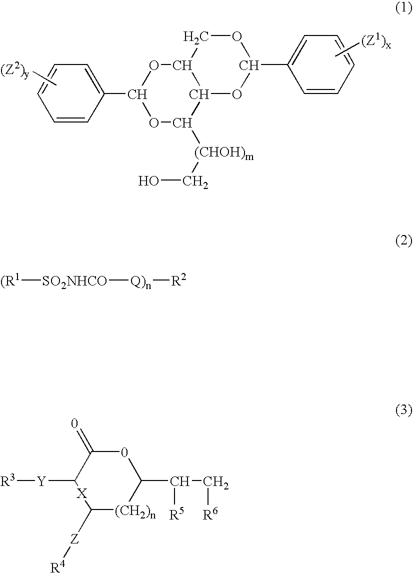

### TECHNICAL FIELD

The present invention relates to a polyolefin resin composition containing a diacetal composition having a low melting point, and containing one member selected from modifiers including sulfonamide compounds, ascorbic acid and derivatives thereof.

### BACKGROUND ART

In recent years, diacetal compounds have frequently been used as a clarifier for polyolefin resins, particularly polypropylene resins. These diacetal compounds can impart transparency function to a resin only after they are dissolved in a polyolefin resin.

However, since diacetals have generally a high melting point, their insoluble part becomes white spots, and thus they are apt to easily cause a trouble that commodity value of such resin is deteriorated.

Although there is a method of dissolving diacetals in a resin at a temperature not lower than their melting point, it is not preferable to handle diacetals under a high temperature for a long time, because thermal degradation takes place and a nasty smell comes therefrom.

JP-A-6-145431 (corresponding to U.S. Pat. No. 5,198,484) describes a method of formulating diacetals into very fine particles to enhance dispersity in a resin. However, in order to formulate diacetals into such fine particles, a special grinder is necessary and, moreover, adverse influence on workers due to dusts is feared.

In addition, JP-A-11-818108 (corresponding to U.S. Pat. No. 6,245,843) shows a composition in which a binder such as a neutral or weakly acidic monovalent organic acid is uniformly distributed on the surface of, or in the interior of particulate or powdery dibenzylidenesorbitols (diacetals), as a polyolefin resin clarifier which can be molded at a low temperature.

However, in this method, when used as a clarifier for polyolefin resins, fibrous crystals of dibenzylidene sorbitols must be swollen using an organic solvent, and added to a polyolefin resin after a composition in which a binder is uniformly dispersed is prepared in advance, and thus it cannot be said that this is an economically excellent method.

Japanese Patent No. 3343754 discloses a composition of clarifier for lowering a melting point of a dibenzylidene-polyhydric alcohol derivative by kneading aliphatic carboxylic amide and/or aromatic carboxylic amide with the dibenzylidene-polyhydric alcohol derivative, or by covering the dibenzylidene-polyhydric alcohol derivative with aliphatic carboxylic amide and/or aromatic carboxylic amide, and suppressing occurrence of white spots which are thought to be due to the dibenzylidene-polyhydric alcohol derivative which is undissolved also at processing of a polyolefin resin at a low temperature.

However, when this composition of is used as a clarifier for polyolefin resins, it cannot be said that this method is economically excellent, because the solvent used must be removed after the aliphatic carboxylic acid amide and/or aromatic carboxylic amide is dissolved in ethyl alcohol or the like, and the solution is mixed with, or covered on the dibenzylidene polyhydric alcohol derivative.

In addition, since aliphatic carboxylic acid amide is a compound having the lubricating effect that is used as a lubricant at polyolefin resin procession in some cases, there is a problem that lubricating property at the processing becomes too strong.

In a method of obtaining a polyolefin resin composition excellent in transparency, there is a current demand for a method that is economically advantageous and can easily prepare the composition, and provides a polyolefin resin composition with excellent transparency which hardly generates white spots even when molded at a low temperature.

### DISCLOSURE OF THE INVENTION

A technical problem to be solved by the present invention is to provide a polyolefin resin composition with excellent transparency according to an economically advantageous method capable of easily preparing the composition, by which white spots of supposedly insoluble part of the diacetal are hardly produced, while retaining the original transparency imparted by the diacetal, even molded at a low temperature.

In order to attain the aforementioned object, the present inventors continued to intensively study, and found out that, when a modifier is used jointly upon use of diacetals as a clarifier for polyolefin resins, white spots thought to be an insoluble part of diacetals can be significantly diminished by the modifying effect. Based on these findings, the present invention has been completed.

That is, the present invention relates to:

(1) A polyolefin resin composition, which comprises at least one member selected from the group consisting of (a) a polyolefin resin, (b) at least one kind of diacetals represented by the general formula (1): 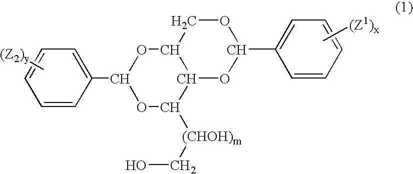
wherein Z¹ and Z² are each the same or different, and represent at least one atom or one monovalent organic group selected from the group consisting of a hydrogen atom, a halogen atom, a carboxyl group, an alkyl group of 1 to 8 carbon atoms, an alkoxy group of 1 to 3 carbon atoms, a nitro group and an amide group; x and y each represents 1 to 5; and m represents 0 or 1), and (c) a modifier,

(2) The polyolefin resin composition according to the above (1), which comprises, as a modifier, at least one member selected from sulfonamide compounds represented by the general formula (2):
(R¹—SO₂NHCO-Q)ₙ-R² (2),
wherein Q represents a direct bond, —O— or —NH—; n represents 1 or 2; a group represented by R¹ represents an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms; a group represented by R² represents, when n is 1, a hydrogen atom, an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms, or when n is 2, an alkylene group of 2 to 18 carbon atoms, a phenylalkylene group of 7 to 9 carbon atoms, a cycloalkylene group of 5 to 8 carbon atoms, a cycloalkylene group of 5 to 8 carbon atoms substituted with an alkyl group of 1 to 4 carbon atoms, a phenylene group, or a phenylene group substituted with an alkyl group of 1 to 9 carbon atoms, or R¹ and R² may be bound to any position of an aromatic ring to form a ring,

(3) The polyolefin resin composition according to the above (2), wherein the sulfonamide compound is at least one member selected from N-benzoyl-4-methylbenzenesulfonamide, N-phenylacetyl-4-methylbenzenesulfonamide, N-benzoyl-methanesulfonamide, o-benzoic sulfimide, N-(2-methylphenoxycarbonyl)-4-methylbenzenesulfonamide, 1,2-bis(4-methylbenzenesulfonylaminocarbonylamino)ethane and 1,4-bis(4-methylbenzenesulfonylaminocarbonyloxy-methyl)benzene,

(4) The polyolefin resin composition according to the above (1), which comprises, as a modifier, at least one member selected from compounds represented by the general formula (3): 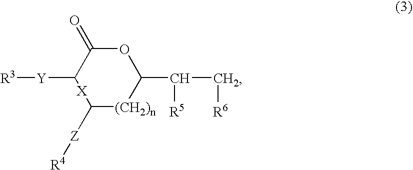
wherein X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde; R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde,

(5) The polyolefin resin composition according to the above (4), wherein a compound represented by the general formula (3): 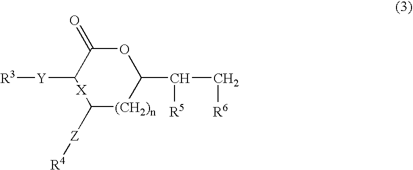
(wherein X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, an acetal group of the hydroxy group with an aldehyde; R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde) is at least one member selected from ascorbic acid, isoascorbic acid, dehydroascorbic acid, ascorbyl palmitate, D-glucono-1,5-lactone, and D-galactono-1,4-lactone,

(6) A diacetal composition, which comprises at least one member selected from at least one diacetal represented by the general formula (1): 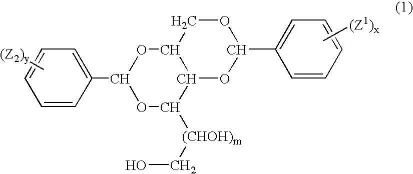
(wherein Z¹ and Z² are each the same or different, and represent at least one atom or one monovalent organic group selected from the group consisting of a hydrogen atom, a halogen atom, a carboxyl group, an alkyl group of 1 to 8 carbon atoms, an alkoxy group of 1 to 3 carbon atoms, a nitro group and an amide group; x and y each represents 1 to 5; and m represents 0 or 1), and a modifier,

(7) The diacetal composition according to the above (6), wherein the modifier is a compound represented by the general formula (2):
(R¹—SO₂NHCO-Q)ₙ-R² (2),
wherein Q represents a direct bond, —O— or —NH—; n represents 1 or 2; a group represented by R¹ represents an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms; a group represented by R² represents, when n is 1, a hydrogen atom, an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms, or when n is 2, an alkylene group of 2 to 18 carbon atoms, a phenylalkylene group of 7 to 9 carbon atoms, a cycloalkylene group of 5 to 8 carbon atoms, a cycloalkylene group of 5 to 8 carbon atoms substituted with an alkyl group of 1 to 4 carbon atoms, a phenylene group, or a phenylene group substituted with an alkyl group of 1 to 9 carbon atoms, or R¹ and R² may be bound to any position of an aromatic ring to form a ring,

(8) The diacetal composition according to the above (6), wherein the modifier is a compound represented by the general formula (3): 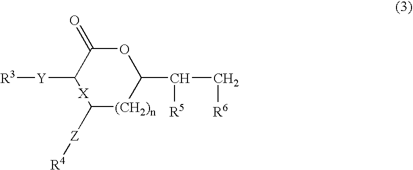
wherein X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde; R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde,

(9) The diacetal composition according to the above (6), wherein an amount of the modifier to be incorporated is 0.4 to 20 parts by weight per 100 parts by weight of the diacetal composition, and

(10) A polyolefin resin composition, which comprises 0.05 to 5 parts by weight of the diacetal composition according to claim 6 per 100 parts by weight of the polyolefin resin.

Examples of the polyolefin resin of the present invention include a homopolymer and a copolymer of α-olefin, specifically, polyethylene, polypropylene, polybutene, 1,2-polybutadiene and ethylene-vinyl acetate copolymer, ethylene-vinyl chloride copolymer, and ethylene-propylene copolymer.

Examples of the diacetal in the present invention include compounds having the same kind of benzylidene groups such as
1,3:2,4-dibenzylidenesorbitol,
1,3:2,4-di(p-methylbenzylidene)sorbitol,
1,3:2,4-di(p-ethylbenzylidene)sorbitol,
1,3:2,4-di(p-chlorobenzylidene)sorbitol,
1,3:2,4-bis(2,4-dimethylbenzylidene)sorbitol, and
1,3:2,4-bis(3,4-dimethylbenzylidene)sorbitol;
   compounds having different kind of benzylidene groups such as
1,3-benzylidene-2,4-p-methylbenzylidenesorbitol,
1,3-p-methylbenzylidene-2,4-benzylidenesorbitol,
1,3-benzylidene-2,4-p-ethylbenzylidenesorbitol,
1,3-p-ethylbenzylidene-2,4-benzylidenesorbitol,
1,3-benzylidene-2,4-p-chlorobenzylidenesorbitol,
1,3-p-chlorobenzylidene-2,4-benzylidenesorbitol,
1,3-benzylidene-2,4-(2,4-dimethylbenzylidene)sorbitol,
1,3-(2,4-dimethylbenzylidene)-2,4-benzylidenesorbitol,
1,3-benzylidene-2,4-(3,4-dimethylbenzylidene)sorbitol,
1,3-(3,4-dimethylbenzylidene)-2,4-benzylidenesorbitol,
1,3-p-methylbenzylidene-2,4-p-ethylbenzylidenesorbitol,
1,3-p-ethylbenzylidene-2,4-p-methylbenzylidenesorbitol,
1,3-p-methyl-benzylidene-2,4-p-chlorobenzylidenesorbitol,
   and
1,3-p-chlorobenzylidene-2,4-p-methylbenzylidenesorbitol;
   compounds having the same kind of benzylidene groups such as
1,3:2,4-dibenzylidene xylitol,
1,3:2,4-di(p-methylbenzylidene)xylitol,
1,3:2,4-di(p-ethylbenzylidene)xylitol,
1,3:2,4:di(p-chlorobenzylidene)xylitol,
1,3:2,4-bis(2,4-dimethylbenzylidene)xylitol, and
1,3:2,4-bis(3,4-dimethylbenzylidene)xylitol; and
   compounds having different kind of benzylidene groups such as
b 1,3-benzylidene-2,4-p-methylbenzylidenexylitol,
1,3-p-methylbenzylidene-2,4-benzylidenexylitol,
1,3-benzylidene-2,4-p-ethylbenzylidenexylitol,
1,3-p-ethylbenzylidene-2,4-benzylidenexylitol,
1,3-benzylidene-2,4-p-chlorobenzylidenexylitol,
1,3-p-chlorobenzylidene-2,4-benzylidenexylitol,
1,3-benzylidene-2,4-(2,4-dimethylbenzylidene)xylitol,
1,3-(2,4-dimethylbenzylidene)-2,4-benzylidenexylitol,
1,3-benzylidene-2,4-(3,4-dimethylbenzylidene)xylitol,
1,3-(3,4-dimethylbenzylidene)-2,4-benzylidenexylitol,
1,3-p-methylbenzylidene-2,4-p-ethylbenzylidenexylitol,
1,3-p-ethylbenzylidene-2,4-p-methylbenzylidenexylitol,
1,3-p-methylbenzylidene-2,4-p-chlorobenzylidenexylitol, and
1,3-p-chlorobenzylidene-2,4-p-methylbenzylidenexylitol.
   Particularly preferable examples include
1,3:2,4-dibenzylidenesorbitol (hereinafter, also referred to as DBS), 1,3:2,4-di(p-methylbenzylidene)sorbitol (hereinafter, also referred to as MBS),
1,3:2,4-di(p-ethylbenzylidene)sorbitol (hereinafter, also referred to as EBS),
1,3:2,4-bis(3,4-dimethylbenzylidene)sorbitol (hereinafter, also referred to as 34DMBS), and 1,3:2,4-dibenzylidenexylitol.
   These are used alone or in an appropriate combination of two or more such compounds.

Further, the diacetal composition of the present invention may contain a monoacetal and a triacetal in addition to the diacetal, and these may be alone or may contain two or more compounds thereof.

An amount of diacetal in the present invention to be used is preferably 0.05 to 5 parts by weight, particularly preferably 0.1 to 1 part by weight relative to 100 parts by weight of a polyolefin resin. When the amount is less than 0.05 parts by weight, improvement in transparency effect is hardly seen. When the amount is greater than 5 parts by weight, not only the effect becomes saturated, but also a product becomes expensive, which is not preferable. In addition, a product may be colored.

The modifier of the present invention refers to an agent which lowers a melting point of diacetal, and prevents or decreases white spots of a polyolefin resin, and refers to a compound represented by the general formula (2) or (3).

In the compound of the present invention represented by the general formula (2), Q represents a direct bond, —O— or —NH—; n represents 1 or 2; a group represented by R¹ represents an alkyl group of 1 to 18 carbon atoms, a phenylalkyl group of a 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms; when n is 1, a group represented by R² represents a hydrogen atom, an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms, or when n is 2, R² represents an alkylene group of 2 to 18 carbon atoms, a phenylalkylene group of 7 to 9 carbon atoms, a cycloalkylene group of 5 to 8 carbon atoms, a cycloalkylene group of 5 to 8 carbon atoms substituted with an alkyl group of 1 to 4 carbon atoms, a phenylene group, or a phenylene group substituted with an alkyl group of 1 to 9 carbon atoms, and R¹ and R² may be bound to any position of an aromatic ring to form a ring.

Examples of the compounds represented by the general formula (2) include:
N-acetyl-4-methylbenzenesulfonamide,
N-benzoyl-4-methylbenzenesulfonamide,
N-phenylacetyl-4-methylbenzenesulfonamide,
N-stearoyl-4-methylbenzenesulfonamide,
N-benzoyl-methanesulfonamide,
o-benzoic sulfimide (saccharin),
N-ethoxycarbonyl-4-methylbenzenesulfonamide,
N-phenoxycarbonyl-benzenesulfonamide,
N-phenylethoxycarbonyl-methanesulfonamide,
N-butoxycarbonyl-benzenesulfonamide,
N-propylaminocarbonyl-benzenesulfonamide,
N-phenylaminocarbonyl-4-methylbenzenesulfonamide,
N-stearylaminocarbonyl-4-methylbenzenesulfonamide,
N-laurylaminocarbonyl-methanesulfonamide,
1,4-bis(4-methylbenzenesulfonylaminocarbonyl)butane,
1,4-bis(benzenesulfonylaminocarbonyl)benzene,
1,2-bis(benzenesulfonylaminocarbonyloxy)ethane,
1,3-bis(methanesulfonylaminocarbonyloxymethyl)benzene,
1,6-bis(benzenesulfonylaminocarbonylamino)hexane,
N-acetyl-benzylsulfonamide,
N-benzoyl-cyclohexylsulfonamide,
N-phenylaminocarbonyl-4-methylcyclohexylsulfonamide,
N-cyclohexyloxycarbonyl-benzenesulfonamide,
N-(4-methylcyclohexyl)aminocarbonyl-4-methylbenzenesulfonamide,
N-(2-methylphenoxycarbonyl)-4-methylbenzenesulfonamide,
N-cyclohexylaminocarbonyl-4-methylbenzenesulfonamide,
1,2-bis(4-methylbenzenesulfonylaminocarbonylamino)ethane, and
1,4-bis(4-methylbenzenesulfonylaminocarbonyloxy-methyl)benzene, among which are particularly preferred
N-benzoyl-4-methylbenzenesulfonamide,
N-phenylacetyl-4-methylbenzenesulfonamide,
N-benzoyl-methanesulfonamide,
o-benzoic sulfimide (saccharin),
N-(2-methylphenoxycarbonyl)-4-methylbenzenesulfonamide,
1,2-bis(4-methylbenzenesulfonylaminocarbonyl-amino)ethane and
1,4-bis(4-methylbenzenesulfonylaminocarbonyloxy-methyl)benzene. Inter alia, saccharin is preferable. Since saccharin has a high melting point (226 to 230° C.), is hardly degraded, and is a food additive, it is excellent in a respect of hygiene and safety for resins which are contacted with foods.

These are used alone, or by appropriately combining two or more kinds of such compounds.

The compound represented by the general formula (2) used in the present invention can be synthesized according to the method described in Journal of Chemical Society, pp. 110 to 112 (1948).

In the compound of the present invention represented by the general formula (3), X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde; and R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde.

When X is a single bond, and Y and Z are a double bond, R³ and R⁴ represent an oxygen atom. When X is a double bond, and Y and Z are a single bond, R³ and R⁴ represent a hydroxy group, an ester group of the hydroxy group with an inorganic acid (e.g. phosphoric acid, polyphosphoric acid, sulfuric acid, etc.) or an organic acid (e.g. palmitic acid, stearic acid, etc.), a glycoside group of the hydroxy group with a saccharide (e.g. glucose, galactose, etc.), a ketal group of the hydroxy group with a ketone, or an acetal group of the hydroxy group with an aldehyde.

Examples of the compounds represented by the general formula (3) include ascorbic acid, isoascorbic acid, dehydroascorbic acid, ascorbic acid-2-phosphate, ascorbic acid-3-phosphate, ascorbic acid-6-phosphate, ascorbic acid-2-polyphosphate, ascorbic acid-2-sulfate, ascorbic acid-3-sulfate, ascorbic acid-6-sulfate, ascorbyl palmitate (e.g. ascorbyl 2-palmitate, ascorbyl 6-palmitate), ascorbyl 2-stearate, ascorbyl
6-stearate, ascorbyl 2,6-dipalmitate,
2-O-α-D-glucopyranosylascorbic acid,
6-O-β-D-galactopyranosyl-ascorbic acid,
D-glucono-1,5-lactone, and D-galactono-1,4-lactone.
   Preferable are ascorbic acid, isoascorbic acid, dehydroascorbic acid, ascorbyl palmitate, D-glucono-1,5-lactone, and D-galactono-1,4-lactone. These are used alone, or by appropriately combining two or more kinds thereof.

An amount of the modifier in the present invention to be used is preferably 0.0002 to 1 parts by weight, particularly preferably 0.0004 to 0.2 parts by weight relative to 100 parts by weight of a polyolefin resin. When the amount is less than 0.0002 parts by weight, preventing effect on white spots formation is hardly seen. When the amount is greater than 1 parts by weight, not only the effect becomes saturated, but also a product becomes expensive, which is not preferable. In addition, a product may be colored.

As a method of obtaining a diacetal composition containing at least one kind compound selected from a modifier, a powder of a modifier and a powder of diacetal may be kneaded. When they are kneaded densely, the modifier is dissolved in a suitable solvent, for example, alcohols such as methanol and ethanol, and mixed with a powder of the diacetal or with its solution in a suitable solvent or dispersion, and a solvent or a liquid medium may be separated by evaporation or a suitable means.

As in the method disclosed in Japanese Patent No. 1517238, a surface of a diacetal powder may be covered with a modifier.

Further, as in the method disclosed in JP-A No. 11-818108 (corresponding to U.S. Pat. No. 6,245,843), a modifier may be uniformly dispersed in diacetal particles.

In the diacetal composition of the present invention, it is necessary that a modifier is mixed at a ratio of 0.4 to 20 parts by weight relative to 100 parts by weight of diacetal. Preferably, a modifier is 0.5 to 10 parts by weight. When the modifier is less than 0.4 parts by weight, the effect of lowering a melting point is small. When the modifier is more than 20 parts by weight, not only the effect of lowering a melting point becomes saturated, but also a product becomes expensive, which is not preferable.

A lubricant, an antistatic agent, a neutralizing agent, a stabilizer, and a polymer in addition to the modifier may be added to the diacetal composition of the present invention in such a range that the effect of the present invention is not deteriorated.

Examples of the lubricant include aliphatic hydrocarbons such as liquid paraffin; higher fatty acids (of 8 to 22 carbon atoms) such as stearic acid; higher fatty alcohols (of 8 to 22 carbon atoms) such as stearyl alcohol; esters of higher fatty acids (of 8 to 22 carbon atoms) and higher aliphatic monovalent alcohols (of 8 to 22 carbon atoms) such as polyglycol, and stearyl stearate; and higher fatty acid (of 8 to 22 carbon atoms) amides such as stearic acid amide, and N,N-ethylenebisstearic acid amide.

Examples of the neutralizing agent or stabilizer include metal soaps such as calcium stearate, and lithium stearate; phenol-based compounds such as tetrakis[methylene-3-(3′,5′-di-tert-butyl-4′-hydroxyphenyl)propionate]methane, and 2,6-di-tert-butyl-4-methylphenol; phosphorus compounds such as tris(2,4-di-tert-butylphenyl)phosphate; and sulfur compounds such as distearyl 3,3′-thiodipropionate.

Examples of the antistatic agent include propylene glycol fatty acid (of 8 to 22 carbon atoms) esters such as propylene glycol monostearate; pentaerythritol fatty acid (of 8 to 22 carbon atoms) esters such as pentaerythritol monooleate; polyoxyethylene (4 to 50 moles) alkyl (of 12 to 22 carbon atoms) ethers such as polyoxyethylene lauryl ether; polyoxyethylene (4 to 50 moles) distyrenated phenyl ether; sorbitan fatty acid (of 4 to 22 carbon atoms) mono-, di-, tri- and tetraesters such as sorbitan distearate; polyoxyethylene (4 to 50 moles) sorbitan fatty acid (of 4 to 22 carbon atoms) esters such as polyoxyethylene sorbitan tristearate; glycerin fatty acid (of 8 to 22 carbon atoms) mono-, di- and triesters such as stearic acid monoglyceride; polyethylene glycol (4 to 50 moles) fatty acid (of 8 to 22 carbon atoms) esters such as polyethylene glycol monolaurate; alkyl (of 12 to 22 carbon atoms) sulfate ester salts such as sodium lauryl sulfate; polyoxyethylene (4 to 50 moles) alkyl (of 12 to 22 carbon atoms) ether sulfate ester salts such as sodium polyoxyethylene lauryl ether sulfate; alkyl (of 12 to 22 carbon atoms) benzenesulfonate salts such as sodium dodecylbenzenesulfonate; alkyl (of 12 to 22 carbon atoms) naphthalenesulfonate salts; and sodium salts of naphthalene sulfonic acid/formalin condensates.

Examples of the above polymer include polyethylene, polypropylene, hydrogenated petroleum resin, hydrogenated terpene resin, ethylene-propylene rubber, and polyvinyl alcohol, all of which have a molecular weight of 10,000 or less.

An amount of a diacetal composition to be used relative to a polyolefin resin in the present invention is such that a diacetal composition is preferably 0.05 to 5 parts by weight, particularly preferably 0.1 to 1 part by weight relative to 100 parts by weight of a polyolefin resin. When the amount is less than 0.05 parts by weight, improvement in transparency effect is hardly seen. When the amount is greater than 5 parts by weight, not only the effect becomes saturated, but also a product becomes expensive, which is not preferable. In addition, a product may be colored.

In order to prepare the polyolefin resin composition of the present invention, a predetermined amount of diacetal represented by the general formula (1) and a modifier are weighed, respectively, and this is mixed into a polyolefin resin, or a prescribed amount of a diacetal composition in which a diacetal represented by the general formula (1) and a modifier are mixed, is weighed, and may be mixed into a polyolefin resin.

Further, if necessary, an antioxidant, an ultraviolet-ray absorbing agent, a light stabilizer or other additives may be mixed into a polyolefin resin, and the mixture may be kneaded after mixing or may be subjected to a step such as extrusion.

The thus obtained polyolefin resin composition can be molded into a product having very little white spots, and excellent transparency, for example, by an injection molding method, an extrusion molding method, a blow molding method or the like.

### BEST MODE FOR CARRYING OUT THE INVENTION

The present invention will be explained specifically below by way of Synthetic Examples and Working Examples, but it goes without saying that the present invention is not limited to them.

Respective symbols used in the Working Examples have the following meanings.
MBS: 1,3:2,4-di(p-methylbenzylidene)sorbitol
DBS: 1,3:2,4-dibenzylidenesorbitol
EBS: 1,3:2,4-di(p-ethylbenzylidene)sorbitol
34DMBS: 1,3:2,4-di(3,4-dimethylbenzylidene)sorbitol

Melting points, haze values (transparency) and white spots (dispersity) shown in the Synthetic Examples and Working Examples were assessed as follows:

<Melting Point>

Using a differential scanning calorimeter “DSC-60” manufactured by Shimadzu Corporation, a temperature was raised at a rate of 10° C. per minute under a nitrogen stream, and an endothermic peak temperature derived from diacetals was adopted as a melting point. About 5 mg of a sample was taken and, as a standard sample, an alumina powder was used.

<Haze Value (Transparency)>

Using a hazemeter (NDH2000) manufactured by Nippon Denshoku Industries Co., Ltd., a haze value was measured according to JIS K7105. As the resulting numerical value is smaller, transparency is excellent.

<White Spot (Dispersity)>

White spots in five test pieces were observed with naked eyes, and were assessed based on the following three stages. A fewer white spots means that practicability is excellent.

⊚: No white spot is observed with naked eyes, and transparency is high.

◯: A small white spot as observed with naked eyes is slightly perceived.

X: A white spot is clearly perceived with naked eyes.

### SYNTHETIC EXAMPLE 1

### N-acetyl-4-methylbenzenesulfonamide

A 200 mL four-neck flask equipped with a stirring device was charged with 17.1 g of p-toluenesulfonamide and 15.8 g of pyridine, and the mixture was stirred so that crystals were dissolved. To this solution was added dropwise a mixed solution of 7.9 g of acetyl chloride and 20 mL of toluene and, after completion of the addition, the materials were reacted at 80° C. for 6 hours. After completion of the reaction, toluene and water were added thereto, and the mixture was washed and separated. The toluene layer was concentrated to give a residue, which was recrystallized from water to afford the objective compound as white crystals, m.p. 140° C. (Compound 1)

### SYNTHETIC EXAMPLES 2 to 5

According to the same manner as that of Synthetic Example 1, among compounds represented by the general formula (2), compounds shown in Table 1 in which Q is a direct bond and n is 1 were synthesized (Compounds 2 to 5).

TABLE 1

| | R¹—SO₂NHCO—R² | | |
|---|---|---|---|
| Compound | R¹ | R² | Melting point |
| N-benzoyl-4- | Methylphenyl | Phenyl | 149° C. |
| methylbenzenesulfonamide | | | |
| (Compound 2) | | | |
| N-phenylacetyl-4- | Methylphenyl | Benzyl | 151° C. |
| methylbenzenesulfonamide | | | |
| (Compound 3) | | | |
| N-stearoyl-4- | Methylphenyl | C₁₇H₃₅ | 98° C. |
| methylbenzenesulfonamide | | | |
| (Compound 4) | | | |
| N-benzoyl- | Methyl | Phenyl | 154° C. |
| methanesulfonamide | | | |
| (Compound 5) | | | |

### SYNTHETIC EXAMPLE 6

### N-(2-methylphenoxycarbonyl)-4-methylbenzenesulfonamide

A 200 mL four-neck flask equipped with a stirring device was charged with 9.9 g of p-toluenesulfonyl isocyanate and 100 mL of toluene. To this solution was added dropwise a mixed solution of 5.4 g of 2-methylphenol and 10 mL of toluene. After completion of the addition, 5 droplets of pyridine were added dropwise, and the reaction was carried out at 20° C. for 5 hours. After completion of the reaction, the reaction solution was concentrated. The residue was washed well with aqueous methanol to obtain the objective compound as white crystals, m.p. 123° C. (Compound 6)

### SYNTHETIC EXAMPLES 7 to 10

According to the same manner as that of Synthetic Example 6, among compounds represented by the general formula (2), the compounds shown in Table 2 were synthesized (Compounds 7 to 10).

TABLE 2

| | R¹—(SO₂NHCO-Q)ₙ-R² | | | | |
|---|---|---|---|---|---|
| Compound | n | Q | R¹ | R² | Melting point |
| N-phenylaminocarbonyl-4- | 1 | NH | Methylphenyl | Phenyl | 171° C. |
| methylbenzenesulfonamide (Compound 7) | | | | | |
| N-cyclohexylaminocarbonyl-4- | 1 | NH | Methylphenyl | Cyclohexyl | 173° C. |
| methylbenzenesulfonamide (Compound 8) | | | | | |
| 1,2-Bis(4-methylbenzenesulfonylamino- | 2 | NH | Methylphenyl | Ethylene | 198° C. |
| carbonylamino)ethane (Compound 9) | | | | | |
| 1,4-Bis(4-methylbenzenesulfonylamino- | 2 | O | Methylphenyl | 1,4-xylylene | 171° C. |
| carbonyloxymethyl)benzene (Compound 10) | | | | | |

### WORKING EXAMPLE 1

0.2 Parts by weight of MBS, 0.006 parts by weight of saccharin and 0.1 parts by weight of liquid paraffin were incorporated relative to 100 parts by weight of random polypropylene (MFR=7.0 g/10 min), and the materials were mixed with a tumbler shaker mixer.

Then, the mixture was melted and kneaded with a biaxial extruder at 230° C., and the resulting strand was cooled with water, and cut to obtain pellets.

The resulting pellets were injection-molded at a molding temperature of 220° C. and a mold temperature of 40° C. to prepare a propylene resin piece having a thickness of 2 mm, and a haze value measured and white spots of the resin piece were assessed. The resulting results are shown in Table 3.

### WORKING EXAMPLES 2 to 5

According to the same manner as that of Working Example 1 except that parts by weight described in Table 3 of a compound of Synthetic Example 1, 2, 3 or 5 (Compound 1, 2, 3 or 5) was incorporated in place of saccharin of Working Example 1, a polypropylene resin piece was prepared. A haze value measured and white spots of the resulting resin piece were assessed, and the results are shown in Table 3.

### COMPARATIVE EXAMPLE 1

According to the same manner as that of Working Example 1 except that 0.006 parts by weight of saccharin of Working Example 1 was not incorporated, a polypropylene resin piece was prepared. A haze value measured and white spots of the resulting resin piece were assessed, and the results are shown in Table 3.

### WORKING EXAMPLE 6

According to the same manner as that of Working Example 1 except that a molding temperature was 250° C., a polypropylene resin piece was made. A haze value measured and white spots of the resulting resin piece were assessed, and the results are shown in Table 3.

### WORKING EXAMPLES 7 to 11

According to the same manner as that of Working Example 1 except that parts by weight described in Table 3 of a compound of Synthetic Example 1, 2, 3, 4 or 5 (Compound 1, 2, 3, 4 or 5) was incorporated in place of saccharin of Working Example 1, and a molding temperature was 250° C., a polypropylene resin piece was made. A haze value measured and white spots of the resulting resin piece were assessed, and the results are shown in Table 3.

### COMPARATIVE EXAMPLE 2

According to the same manner as that of Comparative Example 1 except that a molding temperature was 250° C., a polypropylene resin piece was made. A haze value measured and white spots of the resulting resin piece were assessed, and the results are shown in Table 3.

TABLE 3

| | Diacetal | | Modifier | | Molding | Haze | |
|---|---|---|---|---|---|---|---|
| | | Amount added | | Amount added | temperature | value | White |
| | Kind | (parts by weight) | Kind | (parts by weight) | (° C.) | (%) | spot |
| Working Example 1 | MBS | 0.2 | Saccharin | 0.006 | 220 | 27 | ⊚ |
| Working Example 2 | MBS | 0.2 | Compound 1 | 0.006 | 220 | 28 | ◯ |
| Working Example 3 | MBS | 0.2 | Compound 2 | 0.006 | 220 | 28 | ◯ |
| Working Example 4 | MBS | 0.2 | Compound 3 | 0.006 | 220 | 28 | ◯ |
| Working Example 5 | MBS | 0.2 | Compound 5 | 0.006 | 220 | 28 | ◯ |
| Comparative Example 1 | MBS | 0.2 | — | — | 220 | 29 | X |
| Working Example 6 | MBS | 0.2 | Saccharin | 0.006 | 250 | 29 | ⊚ |
| Working Example 7 | MBS | 0.2 | Compound 1 | 0.006 | 250 | 30 | ◯ |
| Working Example 8 | MBS | 0.2 | Compound 2 | 0.006 | 250 | 30 | ⊚ |
| Working Example 9 | MBS | 0.2 | Compound 3 | 0.006 | 250 | 30 | ⊚ |
| Working Example 10 | MBS | 0.2 | Compound 4 | 0.02 | 250 | 30 | ◯ |
| Working Example 11 | MBS | 0.2 | Compound 5 | 0.02 | 250 | 30 | ⊚ |
| Comparative Example 2 | MBS | 0.2 | — | — | 250 | 31 | X |

### WORKING EXAMPLES 12 to 15

100 Parts by weight of MBS and parts by weight described in Table 4 of saccharin were sufficiently mixed (dry mixing) with an Oster blender. The melting points of the resulting compositions are shown in Table 4.

### WORKING EXAMPLES 16 to 18

Parts by weight described in Table 4 of saccharin and 120 parts by weight of methanol were added to a reactor equipped with a stirring device, and the materials were dissolved by stirring. To this solution was added 100 parts by weight of MBS, and the mixture was sufficiently stirred and mixed, and then methanol was distilled off under reduced pressure. The resulting mixture (wet mixing) was sufficiently dried. The melting points of the resulting compositions are shown in Table 4.

### COMPARATIVE EXAMPLE 3

100 Parts by weight of MBS and 0.1 parts by weight of saccharin were sufficiently mixed (dry mixing) with an Oster blender. The melting point of the resulting composition is shown in Table 4.

### COMPARATIVE EXAMPLE 4

The melting point of MBS obtained without addition of saccharin is shown in Table 4.

### WORKING EXAMPLES 19 to 21

3 Parts by weight of saccharin was sufficiently mixed (dry mixing) into 100 parts by weight of diacetal described in Table 4 with an Oster blender. The melting points of the resulting compositions are shown in Table 4.

### COMPARATIVE EXAMPLES 5 to 7

The melting points of DBS, EBS and 34 DMBS obtained without addition of saccharin are shown in Table 4.

TABLE 4

| | Diacetal | | Modifier | | | |
|---|---|---|---|---|---|---|
| | | Amount | | Amount | | Melting |
| | | incorporated | | incorporated | Mixing | point |
| | Kind | (parts by weight) | Kind | (parts by weight) | method | (° C.) |
| Working Example 12 | MBS | 100 | Saccharin | 1 | Dry | 208 |
| Working Example 13 | MBS | 100 | Saccharin | 3 | Dry | 204 |
| Working Example 14 | MBS | 100 | Saccharin | 5 | Dry | 195 |
| Working Example 15 | MBS | 100 | Saccharin | 10 | Dry | 198 |
| Working Example 16 | MBS | 100 | Saccharin | 1 | Wet | 219 |
| Working Example 17 | MBS | 100 | Saccharin | 3 | Wet | 200 |
| Working Example 18 | MBS | 100 | Saccharin | 5 | Wet | 196 |
| Comparative Example 3 | MBS | 100 | Saccharin | 0.1 | Dry | 265 |
| Comparative Example 4 | MBS | 100 | — | — | — | 265 |
| Working Example 19 | DBS | 100 | Saccharin | 3 | Dry | 189 |
| Comparative Example 5 | DBS | 100 | — | — | — | 227 |
| Working Example 20 | EBS | 100 | Saccharin | 3 | Dry | 198 |
| Comparative Example 6 | EBS | 100 | — | — | — | 252 |
| Working Example 21 | 34DMBS | 100 | Saccharin | 3 | Dry | 209 |
| Comparative Example 7 | 34DMBS | 100 | — | — | — | 283 |

### WORKING EXAMPLES 22 to 29

100 Parts by weight of MBS and an incorporated amount of a modifier described in Table 5 were sufficiently mixed (dry mixing) with an Oster blender. The melting points of the resulting compositions are shown in Table 5.

TABLE 5

| | Diacetal | | Modifier | | | |
|---|---|---|---|---|---|---|
| | | Amount | | Amount | | Melting |
| | | incorporated | | incorporated | Mixing | point |
| | Kind | (parts by weight) | Kind | (parts by weight) | method | (° C.) |
| Working Example 22 | MBS | 100 | Compound 1 | 10 | Dry | 242 |
| Working Example 23 | MBS | 100 | Compound 2 | 3 | Dry | 241 |
| Working Example 24 | MBS | 100 | Compound 2 | 10 | Dry | 228 |
| Working Example 25 | MBS | 100 | Compound 3 | 3 | Dry | 249 |
| Working Example 26 | MBS | 100 | Compound 3 | 10 | Dry | 237 |
| Working Example 27 | MBS | 100 | Compound 4 | 10 | Dry | 247 |
| Working Example 28 | MBS | 100 | Compound 5 | 3 | Dry | 244 |
| Working Example 29 | MBS | 100 | Compound 5 | 10 | Dry | 224 |

### WORKING EXAMPLE 30

0.2 Parts by weight of the composition of Working Example 12 in terms of pure diacetal and 0.1 parts by weight of liquid paraffin were incorporated relative to 100 parts by weight of random polypropylene (MFR=7.0 g/10 min), and the materials were mixed with a tumbler shaker mixer.

Then, the mixture was melted and kneaded with a biaxial extruder at 230° C., and a strand was cooled with water, and then cut to obtain pellets.

The resulting pellets were injection-molded at a molding temperature of 220° C. and a mold temperature of 40° C. to make a polypropylene resin piece having a thickness of 2 mm, and a haze value measured and white spots of the resin piece were assessed. The results obtained are shown in Table 6.

### WORKING EXAMPLES 31 to 36

According to the same manner as that of Working Example 30 except that the composition of Working Example 13, 14, 15, 24, 26 or 29 was incorporated in 0.2 parts by weight in terms of pure diacetal in place of the composition of Working Example 12, a polypropylene resin piece was made. A haze value measured and white spots of the resulting resin piece were assessed, and the results are shown in Table 6.

### WORKING EXAMPLES 37 to 41

According to the same manner as that of Working Example 30 except that the composition of Working Example 15, 22, 23, 26 or 28 was incorporated in 0.2 parts by weight in terms of pure diacetal in place of the composition of Working Example 12, and a molding temperature was 250° C., a polypropylene resin piece was made. A haze value measured and white spots of the resulting resin piece were assessed, and the results are shown in Table 6.

TABLE 6

| | | Diacetal (pure | | | |
|---|---|---|---|---|---|
| | | content) | Molding | Haze | |
| | | Amount added | temperature | value | White |
| | Kind of modifier | (parts by weight) | (° C.) | (%) | spot |
| Working Example 30 | Composition of Example 12 | 0.2 | 220 | 29 | ◯ |
| Working Example 31 | Composition of Example 13 | 0.2 | 220 | 29 | ⊚ |
| Working Example 32 | Composition of Example 14 | 0.2 | 220 | 29 | ⊚ |
| Working Example 33 | Composition of Example 15 | 0.2 | 220 | 28 | ⊚ |
| Working Example 34 | Composition of Example 24 | 0.2 | 220 | 27 | ◯ |
| Working Example 35 | Composition of Example 26 | 0.2 | 220 | 29 | ◯ |
| Working Example 36 | Composition of Example 29 | 0.2 | 220 | 27 | ◯ |
| Comparative Example 1 | MBS | 0.2 | 220 | 29 | X |
| Working Example 37 | Composition of Example 15 | 0.2 | 250 | 29 | ⊚ |
| Working Example 38 | Composition of Example 22 | 0.2 | 250 | 29 | ⊚ |
| Working Example 39 | Composition of Example 23 | 0.2 | 250 | 29 | ⊚ |
| Working Example 40 | Composition of Example 26 | 0.2 | 250 | 31 | ◯ |
| Working Example 41 | Composition of Example 28 | 0.2 | 250 | 30 | ◯ |
| Comparative Example 2 | MBS | 0.2 | 250 | 31 | X |

### WORKING EXAMPLES 42 to 46

0.2 Parts by weight of MBS, 0.02 parts by weight of one of the compounds of Synthetic Examples 6 to 10 (Compounds 6 to 10) and 0.1 parts by weight of liquid paraffin were incorporated relative to 100 parts by weight of a random polypropylene (MFR=7.0 g/10 min), and the materials were mixed with a tumbler shaker mixer.

Then, the mixture was melted and kneaded with a biaxial extruder at 230° C., and a strand was then cooled with water, and cut to obtain pellets.

The resulting pellets were injection-molded at a molding temperature of 250° C. and a mold temperature of 40° C. to make a polypropylene resin piece having a thickness of 2 mm, and a haze value measured and white spots of the resin piece were assessed. The results obtained are shown in Table 7.

TABLE 7

| | Diacetal | | Modifier | | | | |
|---|---|---|---|---|---|---|---|
| | | Amount | | Amount | Molding | Haze | |
| | | incorporated | | incorporated | temperature | value | White |
| | Kind | (parts by weight) | Kind | (parts by weight) | (° C.) | (%) | spot |
| Working Example 42 | MBS | 0.2 | Compound 6 | 0.02 | 250 | 30 | ◯ |
| Working Example 43 | MBS | 0.2 | Compound 7 | 0.02 | 250 | 29 | ◯ |
| Working Example 44 | MBS | 0.2 | Compound 8 | 0.02 | 250 | 30 | ◯ |
| Working Example 45 | MBS | 0.2 | Compound 9 | 0.02 | 250 | 30 | ◯ |
| Working Example 46 | MBS | 0.2 | Compound 10 | 0.02 | 250 | 30 | ◯ |
| Comparative Example 2 | MBS | 0.2 | — | — | 250 | 31 | X |

### WORKING EXAMPLES 47 to 51

100 Parts by weight of MBS and 10 parts by weight of the compound of Synthetic Examples 6 to 10 (Compounds 6 to 10) were sufficiently mixed (dry mixing) with an Oster blender. The melting points of the resulting compositions are shown in Table 8.

TABLE 8

| | Diacetal | | Modifier | | | |
|---|---|---|---|---|---|---|
| | | Amount | | Amount | | Melting |
| | | incorporated | | incorporated | Mixing | point |
| | Kind | (parts by weight) | Kind | (parts by weight) | method | (° C.) |
| Working Example 47 | MBS | 100 | Compound 6 | 10 | Dry | 233 |
| Working Example 48 | MBS | 100 | Compound 7 | 10 | Dry | 231 |
| Working Example 49 | MBS | 100 | Compound 8 | 10 | Dry | 258 |
| Working Example 50 | MBS | 100 | Compound 9 | 10 | Dry | 256 |
| Working Example 51 | MBS | 100 | Compound 10 | 10 | Dry | 242 |

### WORKING EXAMPLES 52 to 56

0.2 Parts by weight of the composition of Examples 47 to 51 in terms of pure diacetal and 0.1 parts by weight of liquid paraffin were incorporated relative to 100 parts by weight of a random polypropylene (MFR=7.0 g/10 min), and the materials were mixed with a tumbler shaker mixer.

Then, the mixture was melted and kneaded with a biaxial extruder at 230° C., and a strand was cooled with water, and cut to obtain pellets.

The resulting pellets were injection-molded at a molding temperature of 250° C. and a mold temperature of 40° C. to make a polypropylene resin piece having a thickness of 2 mm, and a haze value measured and white spots of the resin piece were assessed. The results obtained are shown in Table 9.

TABLE 9

| | | Diacetal | | | |
|---|---|---|---|---|---|
| | | (pure content) | Molding | Haze | |
| | | Amount added | temperature | value | White |
| | Kind of modifier | (parts by weight) | (° C.) | (%) | spot |
| Working Example 52 | Composition of Example 47 | 0.2 | 250 | 30 | ◯ |
| Working Example 53 | Composition of Example 48 | 0.2 | 250 | 30 | ⊚ |
| Working Example 54 | Composition of Example 49 | 0.2 | 250 | 31 | ◯ |
| Working Example 55 | Composition of Example 50 | 0.2 | 250 | 30 | ⊚ |
| Working Example 56 | Composition of Example 51 | 0.2 | 250 | 30 | ⊚ |
| Comparative Example 2 | MBS | 0.2 | 250 | 31 | X |

### WORKING EXAMPLE 57

100 Parts by weight of 34DMBS and 10 parts by weight of saccharin were sufficiently mixed (dry mixing) with an Oster blender. The melting points of the resulting compositions are shown in Table 10.

TABLE 10

| | Diacetal | | Modifier | | | |
|---|---|---|---|---|---|---|
| | | Amount | | Amount | | Melting |
| | | incorporated | | incorporated | Mixing | point |
| | Kind | (parts by weight) | Kind | (parts by weight) | method | (° C.) |
| Working Example 21 | 34DMBS | 100 | Saccharin | 3 | Dry | 205 |
| Working Example 57 | 34DMBS | 100 | Saccharin | 10 | Dry | 197 |
| Comparative Example 7 | 34DMBS | 100 | — | — | — | 283 |

### WORKING EXAMPLES 58 to 59

According to the same manner as that of Working Example 30 except that the composition of Working Example 21 or Working Example 57 was incorporated at 0.2 parts by weight in terms of pure diacetal in place of the composition of Working Example 12, a polypropylene resin piece was made. A haze value measured and white spots of the resulting polypropylene resin piece were assessed, and the results are shown in Table 11.

### COMPARATIVE EXAMPLE 8

According to the same manner as that of Comparative Example 1 except that MBS was changed into 34DMBS, a polypropylene resin piece was made. A haze value measured and white spots of the resulting resin piece were assessed, and the results are shown in Table 11.

TABLE 11

| | | Diacetal | | | |
|---|---|---|---|---|---|
| | | (pure content) | Molding | Haze | |
| | | Amount added | temperature | value | White |
| | Kind of modifier | (parts by weight) | (° C.) | (%) | spot |
| Working Example 58 | Composition of Example 21 | 0.2 | 220 | 25 | ◯ |
| Working Example 59 | Composition of Example 57 | 0.2 | 220 | 25 | ⊚ |
| Comparative Example 8 | 34DMBS | 0.2 | 220 | 24 | X |

### WORKING EXAMPLE 60

According to the same manner as that of Working Example 1 except that 0.02 parts by weight of ascorbic acid was incorporated in place of saccharin of Working Example 1, a polypropylene resin piece was made. A haze value measured and white spots of the resulting resin piece were assessed, and the results are shown in Table 12.

### WORKING EXAMPLE 61

According to the same manner as that of Working Example 1 except that 0.02 parts by weight of ascorbyl palmitate was incorporated in place of saccharin of Working Example 1, a polypropylene resin piece was made. A haze value measured and white spots of the resulting resin piece were assessed, and the results are shown in Table 12.

TABLE 12

| | Diacetal | | Modifier | | | | |
|---|---|---|---|---|---|---|---|
| | | Amount | | Amount | | | |
| | | incorporated | | incorporated | Molding | Haze | |
| | | (parts by | | (parts by | temperature | value | White |
| | Kind | weight) | Kind | weight) | (° C.) | (%) | spot |
| Working Example 60 | MBS | 0.2 | Ascorbic acid | 0.02 | 220 | 29 | ⊚ |
| Working Example 61 | MBS | 0.2 | Ascorbyl palmitate | 0.02 | 220 | 28 | ⊚ |
| Comparative Example 1 | MBS | 0.2 | — | — | 220 | 29 | X |

### WORKING EXAMPLES 62 to 67

100 Parts by weight of MBS, and 10 parts by weight of ascorbic acid, isoascorbic acid, ascorbyl palmitate, dehydroascorbic acid, D-galactono-1,4-lactone or D-glucono-1,5-lactone were sufficiently mixed (dry mixing) with an Oster blender. The melting points of the resulting compositions are shown in Table 13.

TABLE 13

| | Diacetal | | Modifier | | | |
|---|---|---|---|---|---|---|
| | | Amount | | Amount | | |
| | | incorporated | | incorporated | | Melting |
| | | (parts by | | (parts by | Mixing | point |
| | Kind | weight) | Kind | weight) | method | (° C.) |
| Working Example 62 | MBS | 100 | Ascorbic acid | 10 | Dry | 195 |
| Working Example 63 | MBS | 100 | Isoascorbic acid | 10 | Dry | 174 |
| Working Example 64 | MBS | 100 | Asocorbyl palmitate | 10 | Dry | 208 |
| Working Example 65 | MBS | 100 | Dehydroascorbic acid | 10 | Dry | 207 |
| Working Example 66 | MBS | 100 | D-galactono-1,4-lactone | 10 | Dry | 228 |
| Working Example 67 | MBS | 100 | D-glucono-1,5-lactone | 10 | Dry | 227 |
| Comparative Example 4 | MBS | 100 | — | — | — | 265 |

### WORKING EXAMPLES 68 to 69

According to the same manner as that of Working Example 30 except that the composition of Working Example 60 or Working Example 62 was incorporated at 0.2 parts by weight in terms of pure diacetal in place of the composition of Working Example 12, a polypropylene resin piece was made. A haze value measured and white spots of the resulting resin piece were assessed, and the results are shown in Table 14.

TABLE 14

| | | Diacetal | | | |
|---|---|---|---|---|---|
| | | (pure content) | Molding | Haze | |
| | | Amount added | temperature | value | White |
| | Kind of modifier | (parts by weight) | (° C.) | (%) | spot |
| Working Example 68 | Composition of Working Example 66 | 0.2 | 220 | 28 | ⊚ |
| Working Example 69 | Composition of Working Example 67 | 0.2 | 220 | 28 | ⊚ |
| Comparative Example 1 | MBS | 0.2 | 220 | 29 | X |

### INDUSTRIAL APPLICABILITY

According to the present invention, since a transparent polyolefin resin composition which hardly generates white spots can be obtained by using a combination of a diacetal represented by the general formula (1) with a modifier, while retaining the intact transparency imparted by the diacetal even when molded at a low temperature, the composition is useful as a polyolefin resin composition which is easily prepared and is economically advantageous.

The present application is based on Japanese Patent Application No. 2002-369016 which was filed in Japan, and the content thereof is entirely included in the present specification. In addition, the references including patents and patent applications as herein cited are entirely incorporated into the present application by reference in equal level as the disclosed entire contents thereof. Further, since the present invention other than the above-mentioned specific description and working Examples is apparently able to be carried out, various other modifications and changes will be possible in light of the foregoing description, and thus these modifications and changes are incorporated within the scope of the claims appended hereto.

1. A polyolefin resin composition, which comprises at least one member selected from the group consisting of (a) a polyolefin resin, (b) at least one kind of diacetals represented by the general formula (1): 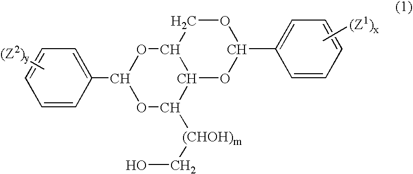
wherein Z¹ and Z² are each the same or different, and represent at least one atom or one monovalent organic group selected from the group consisting of a hydrogen atom, a halogen atom, a carboxyl group, an alkyl group of 1 to 8 carbon atoms, an alkoxy group of 1 to 3 carbon atoms, a nitro group and an amide group; x and y each represents 1 to 5; and m represents 0 or 1), and (c) a modifier:

2. The polyolefin resin composition according to claim 1, which comprises, as a modifier, at least one member selected from sulfonamide compounds represented by the general formula (2):
(R¹—SO₂NHCO-Q)ₙ-R² (2),
wherein Q represents a direct bond, —O— or —NH—; n represents 1 or 2; a group represented by R¹ represents an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms; a group represented by R² represents, when n is 1, a hydrogen atom, an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms, or when n is 2, an alkylene group of 2 to 18 carbon atoms, a phenylalkylene group of 7 to 9 carbon atoms, a cycloalkylene group of 5 to 8 carbon atoms, a cycloalkylene group of 5 to 8 carbon atoms substituted with an alkyl group of 1 to 4 carbon atoms, a phenylene group, or a phenylene group substituted with an alkyl group of 1 to 9 carbon atoms, or R¹ and R² may be bound to any position of an aromatic ring to form a ring.

3. The polyolefin resin composition according to claim 2, wherein the sulfonamide compound is at least one member selected from N-benzoyl-4-methylbenzenesulfonamide,
N-phenylacetyl-4-methylbenzenesulfonamide,
N-benzoyl-methanesulfonamide,
o-benzoic sulfimide,
N-(2-methylphenoxycarbonyl)-4-methylbenzenesulfonamide,
1,2-bis(4-methylbenzenesulfonylaminocarbonylamino)ethane and 1,4-bis(4-methylbenzenesulfonylaminocarbonyloxy-methyl)benzene.

4. The polyolefin resin composition according to claim 1, which comprises, as a modifier, at least one member selected from compounds represented by the general formula (3): 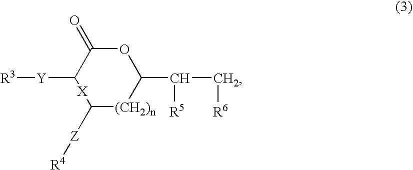
wherein X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde; R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde.

5. The polyolefin resin composition according to claim 4, wherein a compound represented by the general formula (3): 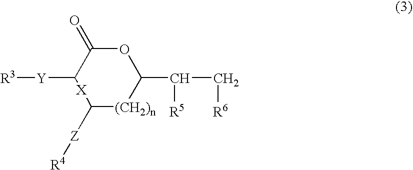
(wherein X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, an acetal group of the hydroxy group with an aldehyde; R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde) is at least one member selected from ascorbic acid, isoascorbic acid, dehydroascorbic acid, ascorbyl palmitate, D-glucono-1,5-lactone, and D-galactono-1,4-lactone.

6. A diacetal composition, which comprises at least one member selected from at least one diacetal represented by the general formula (1): 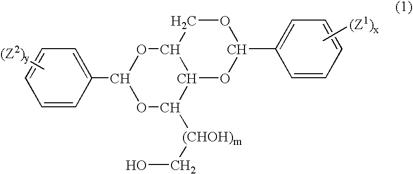
(wherein Z¹ and Z² are each the same or different, and represent at least one atom or one monovalent organic group selected from the group consisting of a hydrogen atom, a halogen atom, a carboxyl group, an alkyl group of 1 to 8 carbon atoms, an alkoxy group of 1 to 3 carbon atoms, a nitro group and an amide group; x and y each represents 1 to 5; and m represents 0 or 1), and a modifier.

7. The diacetal composition according to claim 6, wherein the modifier is a compound represented by the general formula (2):
(R¹—SO₂NHCO-Q)ₙ-R² (2),
wherein Q represents a direct bond, —O— or —NH—; n represents 1 or 2; a group represented by R¹ represents an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms; a group represented by R² represents, when n is 1, a hydrogen atom, an alkyl group of 1 to 18 carbon atoms, a phenylalkyl group of 7 to 9 carbon atoms, a cycloalkyl group of 5 to 8 carbon atoms, a cycloalkyl group of 5 to 8 carbon atoms substituted with an alkyl group of 1 to 4 carbon atoms, a phenyl group, or a phenyl group substituted with an alkyl group of 1 to 9 carbon atoms, or when n is 2, an alkylene group of 2 to 18 carbon atoms, a phenylalkylene group of 7 to 9 carbon atoms, a cycloalkylene group of 5 to 8 carbon atoms, a cycloalkylene group of 5 to 8 carbon atoms substituted with an alkyl group of 1 to 4 carbon atoms, a phenylene group, or a phenylene group substituted with an alkyl group of 1 to 9 carbon atoms, or R¹ and R² may be bound to any position of an aromatic ring to form a ring.

8. The diacetal composition according to claim 6, wherein the modifier is a compound represented by the general formula (3): 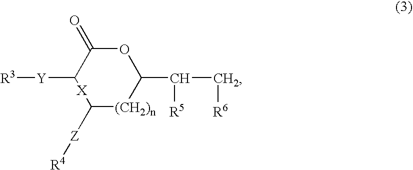
wherein X, Y and Z each represents a single bond or a double bond; n represents 0 or 1; R³ and R⁴ independently represent an oxygen atom, a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde; R⁵ and R⁶ independently represent a hydroxy group, an ester group of the hydroxy group with an inorganic or organic acid, a glycoside group of the hydroxy group with a saccharide, a ketal group of the hydroxy group with a ketone, or an acetal group of the hydroxy group with an aldehyde.

9. The diacetal composition according to claim 6, wherein an amount of the modifier to be incorporated is 0.4 to 20 parts by weight per 100 parts by weight of the diacetal composition.

10. A polyolefin resin composition, which comprises 0.05 to 5 parts by weight of the diacetal composition according to claim 6 per 100 parts by weight of the polyolefin resin.
